(19) United States
(12) Patent Application Publication
(10) Pub. No.: US 2010/0323395 A1
(43) Pub. Date: Dec. 23, 2010

(54) Method For Automatically Processing Tissue Samples In A Tissue Processor

(75) Inventors: Hermann ULBRICH, Bad Schonborn (DE); Stefan KÜNKEL, Karlsruhe (DE)

Correspondence Address: HODGSON RUSS LLP;THE GUARANTY BUILDING, 140 PEARL STREET, SUITE 100, BUFFALO, NY, 14202-4040, US

(73) Assignee: LEICA BIOSYSTEMS NUSSLOCH GMBH, Nussloch (DE)

(21) Appl. No.: 12/788,604

(22) Filed: May 27, 2010

(30) Foreign Application Priority Data
Jun. 19, 2009 (DE) 10 2009 025 574.5

(51) Int. Cl. G01N 1/28

(52) U.S. Cl. 435/40.5

(57) ABSTRACT

In the automatic processing of tissue samples in a tissue processor, the tissue samples are placed in a retort of the tissue processor. The tissue samples are exposed to a fixation reagent (FIX) in the retort. Afterwards, the tissue samples are exposed to a dehydrating reagent (ALK). Thereafter, the retort is cleared with an intermedium (INT) for removing the dehydrating reagent (ALK). Finally, the tissue samples are treated with a carrier material (CAR). Between the clearing of the retort with the intermedium (INT) and the treatment of the tissue samples with the carrier material (CAR), the retort is cleared with a carrier material protecting reagent (CARPRO) in which the intermedium (INT) and the carrier material (CAR) can be mixed.

### CROSS REFERENCE TO RELATED APPLICATIONS

This application claims priority of the German patent application 10 2009 025 574.5 filed Jun. 19, 2009, the entire disclosure of which is incorporated by reference herein.

### FIELD OF THE INVENTION

The invention relates to a method for automatically processing tissue samples in a tissue processor. The tissue samples are placed in a retort of the tissue processor. In the retort, the tissue samples are exposed to a fixation reagent. Thereafter, the tissue samples are exposed to a dehydrating reagent. After dehydration of the tissue samples the retort is cleared with an intermedium for removing the dehydrating reagent. Finally, the tissue samples are treated with a carrier material.

### BACKGROUND OF THE INVENTION

Biological tissue samples, in particular histological tissue samples, are often required in the field of human medicine and veterinary medicine, in particular as a microscopy specimen for the assessment of cells and their environment. For the microscopic investigation thin sections of the tissue sample have to be produced which are assessed by an expert under the microscope with reflected or transmitted light. For producing thin sections, for example with the aid of a microtome, the tissue sample must have a certain stability so that with the aid of a knife thin transparent sections having a thickness in the micrometer range can be produced. For this purpose, the tissue sample first has to run through a treatment process in which it is fixed with a fixation reagent, dehydrated with a dehydrating reagent, cleared with an intermedium and then infiltrated with a carrier material, preferably molten paraffin. These processes are often performed one after the other in one single apparatus, the so-called tissue processor, for which purpose this tissue processor has a closeable process chamber, called retort, which accommodates the different reagents for performing the process steps at a suitable temperature and pressure.

An important process step in this connection is the infiltration of the tissue sample with the carrier material in order to stabilize and harden the sample. Prior to this infiltration process step, the clearing step is performed in which residual alcohol still present from the preceding dehydration step is removed. As a chemical solution for this clearing step xylene or a similar agent is used. In the following infiltration step in which the tissue sample is exposed to the carrier material, mostly molten paraffin, still present xylene components are flushed out and absorbed by the liquid carrier material, as a result whereof the carrier material is contaminated in the retort.

From DE 10 2005 057 191 A1 a tissue processor for processing histological samples with different reagents is known. In the tissue processor there are different reagent containers which are connected to a retort of the tissue processor via a conduit system. The histological samples are placed in the retort and are treated with different reagents one after the other.

From WO 2006/089365 A1, a method and an apparatus for tissue treatment are known, in which liquid paraffin is used for the infiltration of tissue samples.

### SUMMARY OF THE INVENTION

It is the object of the present invention to specify a method for automatically processing tissue samples in a tissue processor which has as little adverse health effects as possible for the people in the surrounding area of the tissue processor and/or contributes to samples of high quality.

The object is solved by the features and advantageous embodiments described herein.

The invention is characterized in that the retort is cleared with a carrier material protecting reagent between the clearing with the intermedium and the treatment of the tissue samples with the carrier material. The carrier material protecting reagent has the property that the intermedium and the carrier material can be mixed in the carrier material protecting reagent. What is meant in this connection by “can be mixed” is the qualitative statement that when mixing at least two of the reagents these completely mix together while forming a single homogeneous phase. The clearing of the retort with the carrier material protecting reagent causes that the intermedium is approximately completely removed from the retort before the carrier material is filled in. As a result thereof, the carrier material is not contaminated by residues of the intermedium. This, on the one hand, contributes to the fact that the finished samples are not contaminated by residues of the intermedium, which improves the quality of the finished sample and facilitates the cutting of the sample into thin sections for microscoping. On the other hand, this contributes to the fact that no residues of the intermedium evaporate from the heated carrier material, which contributes to a healthy atmosphere in the room since the evaporated intermedia regularly contain substances which are harmful for the human being.

In an advantageous embodiment, a carrier material protecting reagent is used which can be mixed in the intermedium and/or the carrier material in an unlimited manner. This means that they can be mixed in any concentration.

As a carrier material protecting reagent, for example, an intermedium substitute reagent can be used. Further, as an intermedium substitute reagent a mixture of an intermedium and a further reagent and/or of the carrier material and the further reagent can be used. As an intermedium, preferably xylene is used. As an intermedium substitute reagent or as the further reagent, substances from the group consisting of the perpenoids, the paraffin oils or the hydrocarbons, in particular the long-chain or short-chain hydrocarbons, are suitable. As an intermedium substitute reagent, in particular isoparaffin can be used.

### BRIEF DESCRIPTION OF THE DRAWING FIGURE

An embodiment of the invention is explained in more detail in the following with reference to a schematic illustration, wherein:

FIG. 1 shows a flow chart of a method for automatically processing tissue samples in a tissue processor.

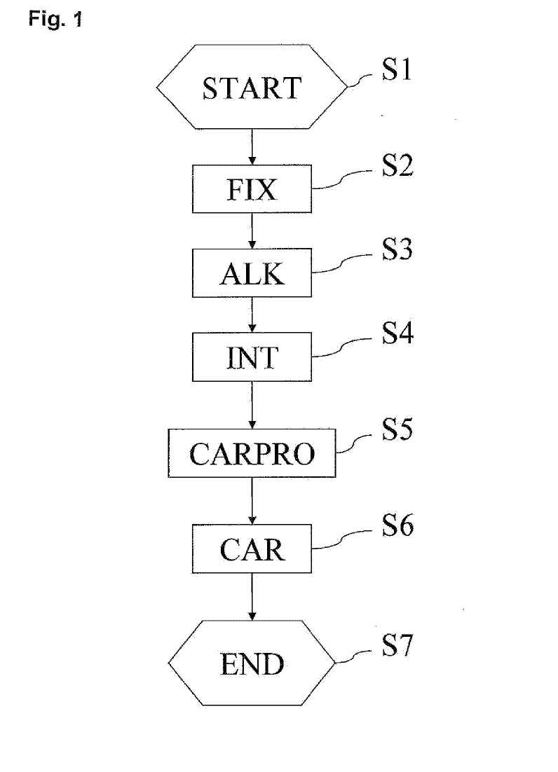

### DETAILED DESCRIPTION OF THE INVENTION

In a step S1, the method is started, for example after the tissue samples have been placed in the retort of the tissue processor.

In a step S2, the tissue samples are treated in the retort with a fixation reagent FIX, typically with formaline.

In a step S3, the samples are treated with a dehydrating reagent ALK, for example alcohol. The dehydrating reagent ALK extracts liquid from the tissue samples.

For removing the dehydrating reagent, the retort is cleared with an intermedium INT in a step S4. As an intermedium INT, xylene is used. Alternatively, isopropanol can likewise be used as an intermedium INT.

So that no residues of the intermedium INT, in particular of the xylene get into the carrier material CAR and via the carrier material CAR into the finished tissue sample, the retort is cleared with a carrier material protecting reagent CARPRO in a step S5. The carrier material protecting reagent CARPRO can be mixed in an unlimited manner in the intermedium and the carrier material CAR. Preferably, an intermedium substitute reagent, in particular a xylene substitute, or a mixture of xylene substitute and intermedium INT or a mixture of xylene substitute and a carrier material CAR is used as a carrier material protecting reagent CARPRO. In particular, different perpenoids, paraffin oils and hydrocarbons are suitable as xylene substitutes. Among these, in particular the isoparaffins and short-chain as well as long-chain hydrocarbons are suitable.

The duration of the clearing operation with the carrier material protecting reagent CARPRO is, for example, ten minutes. The clearing operation can be accelerated in that the carrier material protecting reagent CARPRO is heated in the retort. Before pumping the carrier material protecting reagent CARPRO out of the retort, it can again be cooled down in order to in turn prevent an evaporation of cleared out intermedium residues. The carrier material protecting reagent CARPRO can be stored and reused until a concentration of the intermedium INT in the stored carrier material protecting reagent CARPRO exceeds a predetermined threshold value.

Thereafter, in a step S6 the retort is filled with the carrier material CAR so that the tissue samples are exposed to the carrier material CAR. As a carrier material

CAR, preferably paraffin or wax is used. For treating the tissue samples with the carrier material CAR, the carrier material CAR is molten and typically kept at a temperature of 65° C. Since the intermedium INT has been removed from the tissue samples and the retort in step S5, no residues of the intermedium INT can evaporate in step S6, cause offensive smell and pollute the air surrounding the tissue processor in a way that is harmful to health.

In a step S7, the method can be terminated, for example by removing the tissue samples from the retort of the tissue processor. The finished tissue samples have a particularly high degree of purity since the residues of the intermedium INT were approximately completely removed from the tissue samples in step S6. Such pure tissue samples can be cut particularly easily and precisely into thin sections, for example with the aid of a microtome.

The fact that the carrier material protecting reagent CARPRO can be mixed in the intermedium INT and the carrier material CAR means in particular that this unlimited miscibility is given under conditions normal for the operation of a tissue processor. For example, in the retort, there are temperatures between 0° and 100° and an absolute pressure between 20 kPa and 170 kPa.

The invention is not restricted to the embodiment described. For example, the individual steps S2 to S6 can be divided into further sub-steps. In particular the tissue samples can be treated within one or more of the steps S2 to S6 with the respective reagents in different, in particular increasing degrees of purity.

### LIST OF REFERENCE SIGNS

S1-S7 steps one to seven

START start

FIX fixation reagent

ALK dehydrating reagent

INT intermedium

CARPRO carrier material protecting reagent

CAR carrier material

END end

1. A method for automatically processing tissue samples in a tissue processor, comprising the steps of:
A) placing the tissue samples in a retort of the tissue processor;
B) exposing the tissue samples to a fixation reagent;
C) subsequent to step B, exposing the tissue samples to a dehydrating reagent;
D) subsequent to step C, clearing the retort with an intermedium for removing the dehydrating reagent;
E) subsequent to step D, treating the tissue samples with a carrier material;
F) between steps D and E, clearing the retort with a carrier material protecting reagent in which the intermedium and the carrier material can be mixed.

2. The method according to claim 1, wherein the carrier material protecting reagent can be mixed in the intermedium and/or the carrier material in an unlimited manner.

3. The method according to claim 1, wherein an intermedium substitute reagent is used as the carrier material protecting reagent.

4. The method according to claim 3, wherein a mixture of an intermedium and a further reagent and/or of the carrier material and the further reagent is used as the intermedium substitute reagent.

5. The method according to claim 3, wherein a substance selected from the group consisting of the terpenoids, the paraffin oils and the hydrocarbons is used as the intermedium substitute reagent.

6. The method according to claim 4, wherein a substance selected from the group consisting of the terpenoids, the paraffin oils and the hydrocarbons is used as the intermedium substitute reagent or as the further reagent.

7. The method according to claim 5, wherein isoparaffin is used as the intermedium substitute reagent.

8. The method according to claim 5, wherein a long-chain hydrocarbon or a short-chain hydrocarbon is used as the intermedium substitute reagent.
